(19) United States
(12) Patent Application Publication
(10) Pub. No.: US 2011/0182209 A1
(43) Pub. Date: Jul. 28, 2011

(54) Method and Apparatus for Network Configuration

(76) Inventors: Fabio De Ponti, Zoagli (IT); Gianluca Colla, Genova (IT)

(21) Appl. No.: 13/055,090

(22) PCT Filed: Sep. 9, 2008
(86) PCT No.: PCT/EP08/61920

§ 371 Date: Apr. 6, 2011

(30) Foreign Application Priority Data
Jul. 25, 2008 (EP) 08161187.3

(51) Int. Cl. H04L 12/403

(52) U.S. Cl. 370/257

(57) ABSTRACT

A method of re-configuring connections for a plurality of network access nodes arranged to communicate with a network. The network access nodes connected in a series configuration with only one of the access nodes being connected to the network, the method comprises: connecting a switch node between the network and each of the access nodes using a respective link. Prior to connecting the switch node the method further comprises collecting connection configuration data from the network access nodes connected in series and using at least some of the connection configuration data, and/or data derived from the connection configuration data, to configure the switch node to allow communication between the access nodes and the network via the switch node.

### TECHNICAL FIELD

The present invention relates to a method and apparatus for configuring networks.

### BACKGROUND

It is known that a series of network access equipments are connected to a communication network by an uplink. The network access equipments provide access for customers to connect to the communications network. When the configuration of a first equipment is completed, a second one is connected in daisy chain, or series, fashion, to the first and the same operation is performed for the third such equipment and so on. In this way each of the upstream nodes provides a link towards the communication network for downstream network access equipments.

A shortcoming of this procedure is that the bandwidth of the uplink stream remains the same despite fact that it has to provide a link to the communications network for all of the downstream network access equipments. This leads to the customer effective bandwidth being reduced each time an additional access equipment is added to the daisy chain. In fact, the available bandwidth for each access node is generally in inverse proportion to the number of access equipments which are downstream from a particular access equipment.

To increase the bandwidth available to a customer to reach the communications network from a particular access equipment it is known to substitute a tributary board in an access equipment that performs the connection to the communication network with another tributary card with a greater capacity (for example from 34 Mb/s to 155 Mb/s)

However, this substitution of tributary cards has two problems. Firstly, it is very expensive because there are several cards to substitute. Furthermore, in order to change a card service outage is required since each access equipment database has to be changed which has a negative impact on service.

### SUMMARY

According to one aspect of the invention there is provided a method of re-configuring connections for a plurality of network access nodes arranged to communicate with a network, the network access nodes connected in a series configuration with only one of the access nodes being connected to the network. The method comprises: connecting a switch node between the network and each of the access nodes using a respective link. Prior to connecting the switch node the method further comprises collecting connection configuration data from the network access nodes connected in series and using at least some of the connection configuration data, and/or data derived from the connection configuration data, to configure the switch node to allow communication between the access nodes and the network via the switch node

According to a further aspect of the invention there is provided a network management processor configured to collect connection configuration data from a plurality of network access nodes arranged in series in an access network. The network management processor is configured to configure a switch node using at least some of the connection configuration data, and/or data derived from the connection configuration data, such that the switch node is configured to allow communication between a communications network and the network access nodes via the switch node.

Yet a further aspect of the invention relates to machine-readable, which when run by a data processor, cause the data processor to collect connection configuration data from a plurality of network access nodes connected in series in an access network, and the instructions further cause the data processor to use at least some of the connection configuration data, and/or data derived from the connection configuration data, to configure a switch node such that the switch node is configured to allow communication between a communications network and he network access nodes via the switch node.

The machine-readable instructions may be provided on a data carrier device, or in a signal.

One embodiment of the invention may be viewed as an automated procedure to change network topology

### DESCRIPTION OF DRAWINGS

Various embodiments of the invention will be described, by way of example only, with reference to the accompanying drawings in which:

FIG. 1 shows a communications network and an access network,

FIG. 2 shows a table of configuration data

FIG. 3 shows a communications network and an access network.

FIG. 4 shows a table of configuration data, and

FIG. 5 shows a flow diagram.

### DETAILED DESCRIPTION

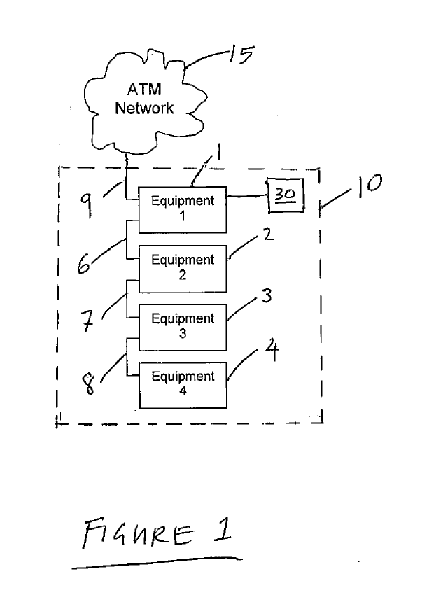

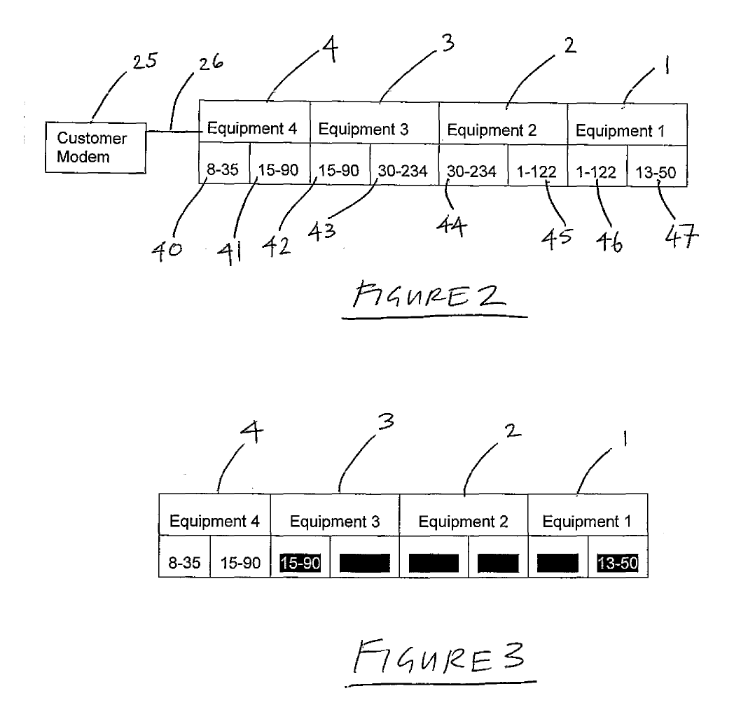

With reference initially to FIG. 1 there is shown an access network 10 comprising a plurality of network access nodes 1, 2 and 3 connected in series, an access network management workstation 30 and the access network 10 being connected to an Asynchronous Transfer Mode (ATM) network 15. The workstation 30 is connected to the network 10 by way of a link 6 from the workstation to the interface 1c of the upstream-most access node 1. The workstation 30 can connect to and communicate with the access nodes 1, 2 and 3 through in-band management. As will be described in the procedure detailed below, this serial configuration, or topology, will be reconfigured to a more advantageous ‘star’ configuration shown in FIG. 3.

Each network access node comprises a Digital Subscriber Line Access Multiplexer (DSLAM) or a Multi Service Access Node (MSAN), for example an AXH600 ATM equipment. Each access node comprises at least one so-called tributary, or interface, card, which is a signal processing device, on each side of a switching fabric. In broad terms, when data is received at a port of a tributary card the data is then switched, or cross-connected, by the switching fabric to a particular port of another tributary card on the other side of the fabric. The switching fabric is controlled by a database of the access node to selectively switch traffic to the required port. The database is configured by using the workstation 30. The database comprises a look-up table or similar data structure which determines to which port received data is to be switched by the switching fabric.

The workstation 30 may comprise a Hewlett Packard® Itanium-Risk, a Sun® Solaris 9 or a Red Hat Linux® ES3.

A subscriber of the access node 3 reaches the node from a customer digital subscriber line modem 25 which is in communication with the access node 3 by way of a link 26. The subscriber then reaches the network 15 by a cross-connection from a line channel of the node 3 to an uplink channel of node 3, across link 8 to upstream node 2, via a bypass cross-connection through the equipment 2, across link 7 to the node 1, via another bypass cross-connection through the equipment 1, and then to a link 9 to the network 15.

The connection configuration data to achieve the connections across access nodes and between the access nodes are now described. As can be seen from FIG. 1 interfaces 1a, 1b, 2a, 2b, 3a and 3c of the access nodes have been labeled with interface identification data and routing data, using the string syntax A/B/C/D/E:F. Each interface of each access node is identified by the following interface identification data (which may be termed ‘relational data’) which identifies the location of each ATM interface:

A=Subrack ID :Defines in which subrack the ATM interface is located
B=Slot ID :Defines in which slot the ATM interface is located
C=Module ID :Defines which modules are used by the ATM interface
D=Port ID :Defines which port the ATM interface belongs to

Interfaces which are connected by a particular link have the following routing data, (which may be termed ‘core data’):

E=Virtual Path Index (Vpi) :This is the used ATM Virtual Path index
F=Virtual Channel Index (Vci) :This is the used ATM Virtual Channel index

For example, from FIG. 1 it can be seen that the interfaces 2b and 3a of the access nodes 2 and 3, which are connected by the link 8, have the same Vpi:Vci data of 35:350. The database of each access node uses the Vpi:Vci fields to identify the next connection between the access nodes that a traffic cell needs to be transmitted to on the cell's way to its final destination.

In order to change the configuration of the access network from that shown in FIG. 1 to that shown in FIG. 3 the following steps are taken. Reference is made to the flow diagram 200 in FIG. 5. Broadly, the access network management workstation 30 comprises a processor configured to first collect all connection configuration data from each of the access nodes. The processor of the workstation is configured to collect the connection configuration data by way of suitable machine-readable instructions. Initially, as shown at step 201, a network administrator is prompted to enter identifications of the access nodes into the workstation. Such identifications may comprise respective IP addresses.

As shown at step 202, the workstation 30 then implements an automated procedure to collect the connection configuration data from the databases of the access nodes.

At step 203 the collected data is collated, and then stored, in a configuration table 20, as shown in FIG. 2. As can be seen in FIG. 2, a header row 40 identifies each access node. For each access node, interface identification data is given in rows 41 and 42, comprising the interface identities, either A or B (e.g. ‘ATM int.A’) and slot and port data for each interface. For each interface, routing data is given in row 43 in Vpi:Vci format. The workstation 30 is configured to understand from the collected connection configuration data how the access nodes are interconnected, and in particular to identify the connection configuration data that are used to achieve the serial connection which allow downstream access nodes to gain access to the communications network 15 via the upstream nodes.

The data in the configuration table 20 is then suitably processed by the workstation 30, at step 204 of FIG. 5, so that a multiplexer 50 and the access nodes 1, 2 and 3 can then be (re)configured appropriately. This processing step 204 involves the workstation 30 determining from the configuration table 20 which of the connection configuration data relate to cross-connections which are required for the access nodes to gain access to the network 15 through the series connections between the access nodes. The workstation 30 is able to determine this by identifying those Vpi:Vci data which are the same for interfaces of different nodes. For example, from FIG. 1 it can be seen that the interfaces 2b and 3a of the access nodes 2 and 3, which are connected by the link 8, have the same Vpi:Vci data of 35:350. It can also be seen from FIG. 1 that the interfaces 1b and 2a of access nodes 1 and 2, connected by link 7, have the same Vpi:Vci of 30:300. The workstation 30 knows which (set of) connection configuration data is associated with which access node because the connection configuration data is identified as being from a particular access node when the data is sent to the workstation 30. Also, from this data it will also be evident to the workstation 30 how the internal connections (i.e. the cross-connections) of each node are configured (i.e how one port is mapped to another port) since this information is stored in each access node's database which is made available to the workstation 30. Accordingly the workstation 30 can determine the connection configuration data relating to the cross-connection between interfaces 2a and 2b will need to be deleted from the database of the access node 2 at step 206.

The workstation 30 also determines which connection configuration data of the access nodes are required to allow a customer equipment, such as the customer modem 25, to provide a connection to an access node. The workstation 30 can determine this by identifying that the identity of the customer modem 25 is not an identity of an access node which has been entered by the network administrator at step 201. If the workstation 30 determines any incomplete chains of connections then they are stored in a database to be analyzed subsequently. Incomplete connections result from data relating to referenced, but non-reachable access nodes, and/or from unused programmed connections.

Once the processing of step 204 has occurred, at step 205 the workstation then configures the multiplexer 50. An interface 50a of the multiplexer, which connects to the link 9 to connect to the communications network 15, is configured to have the same Vpi:Vci data as interface 1a of the access node 1 in the series topology of FIG. 1. An interface 50b, on an opposite side of the multiplexer, is configured to have the same Vpi:Vci data as that of interface 3a of the access node 3. A database of the multiplexer 50 is configured by the workstation 30 to create a cross-connection between the interface 50a and the interface 50b.

After the configuration of the multiplexer 50, at step 206 the connection configuration data of the access nodes, which have been determined by the workstation 30 to relate to providing serial connection between the access nodes in the series topology of FIG. 1, are then caused to be deleted from the databases of those access nodes.

The links 7, 8 and 9, in the form of coaxial cables, are then manually unplugged and connected to respective ports of the interface 50b of the multiplexer 50.

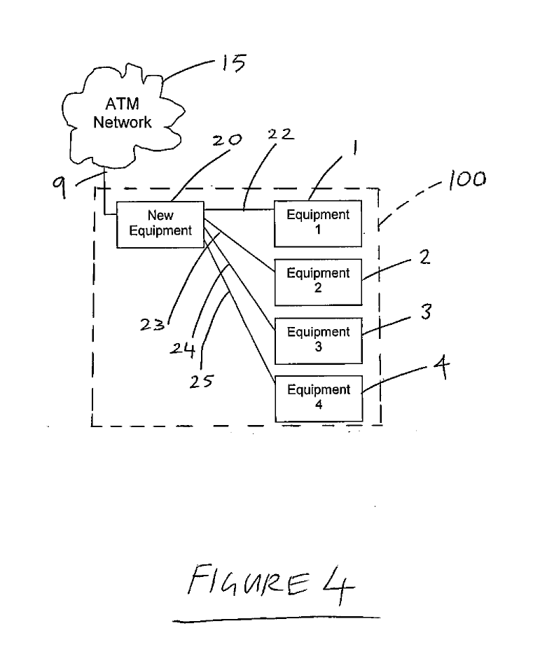

A table 21 showing the revised connection configuration data for the topology of FIG. 3 is shown in FIG. 4. The table 21 shows the connection configuration data of each of the multiplexer 50 and the access node 3.

Advantageously, the multiplexer node 50 has a higher signal processing capacity, as compared to the individual uplink capacity of any of the access nodes 1, 2 and 3. The multiplexer node 50 is thus able to provide improved communication to the network 15 for each of the access nodes 1, 2 and 3.

It will be appreciated that although only one customer modem is shown for the purpose of clarity of explanation, other customer modems could be connected to the access node 3 through other ports of tributary cards of the access node. For example, another customer modem could be connected to the access node 3 with connection configuration data of 1/5/2/11/8:35 for an interface that connects the access node to the modem and connection configuration data of 1/1/2/1/35:351 at the other interface of the access node. As can be readily deduced from comparison of the connection configuration data associated with the interfaces for each modem, the further customer modem enters the access node 3 at a different input port (namely port ID 11) as compared to the modem 25 (which enters at port ID 10). The Vpi:Vci values are the same (namely 8:35) for data cells from both modems and accordingly the access node is configured to cause the access node to switch, or cross-connect, data from both modems to the same port 3a (which has the port ID 1) of the access node. Although data from both modems is sent along the same link 8 to the access node 2, data from the different modems is distinguished by the respective Vci values, namely 250 and 251. It will be appreciated that, in addition, customer modems could be connected to (tributary cards in) each of the access nodes 1 and 2.

There are numerous and important advantages to the above configuration procedure and the arrangement shown in FIG. 3. These include:

Reduced impact on traffic: the reconfiguration procedure described above is performed during the standard functionality of the existing access nodes and then the multiplexer 50 is configured before its in-service status. Whilst the procedure is not completely service outage free the outage is reduced to a very short time. In particular, no outage results whilst the multiplexer node is configured and no outage occurs during the re-configuration of the access nodes. In fact the only service outage occurs when the links are physically disconnected in order to be reconnected to the multiplexer node.

Drastic cost reduction: the known solution to upgrade the bandwidth, in the configuration of FIG. 1, costs the replacement of six processor boards (since there are two such boards per access node). The embodiment of FIG. 3, however, requires only three new boards (two of which are mandatory because of the introduction of the multiplexer node 50). Specifically, the three boards equipped on the multiplexer node 50 are two processor units that perform the management of the multiplexer 50 and an 8xE3 tributary card (which is a processing unit that has the capacity of 8 channels at 45 Mbit/s).

Human error free: the procedure to collect data and install the data onto the multiplexer node 50, and to remove certain cross-connection data from the access nodes is completely automated. The processor of the workstation 30 may be configured to provide an error log for the network administrator.

Reduced time cost: the known solution to upgrade bandwidth whilst maintaining a series configuration requires the manual modification of four equipment databases with the general steps of backup, modification and restore. In contrast, the above-described reconfiguration procedure is executed as a batch operation during normal working time.

Reliability: the procedure can be installed in the workstation 30 which is normally dedicated to the network management.

It will also be appreciated that although only three access nodes are shown, more or fewer access nodes could be connected to the multiplexer node 50.

It will also be appreciated that although only ATM has been referred to above, the procedure could be implemented using other data transmission protocols.

1. A method of re-configuring connections for a plurality of network access nodes arranged to communicate with a network, the network access nodes connected in a series configuration with only one of the access nodes being connected to the network, the method comprising:
connecting a switch node between the network and each of the access nodes using a respective link, and in which prior to connecting the switch node the method further comprises:
collecting connection configuration data from the network access nodes connected in series; and
using at least some of the connection configuration data, and/or data derived from the connection configuration data, to configure the switch node to allow communication between the access nodes and the network via the switch node.

2. The method as claimed in claim 1, in which the connection configuration data comprises routing data for routing traffic from one node to another, and interface identification data to identify interfaces of the access nodes.

3. The method as claimed in claim 2, in which the routing data comprises virtual path identifier data and virtual channel identifier data for packet transmission.

4. The method as claimed in claim 1, in which the connection configuration data is suitable for use in effecting cross-connections across an access node.

5. The method as claimed in claim 1, comprising configuring the switch node to effect cross-connections from a first interface of the switch node to connect to the network to a second interface of the switch node to connect to the access nodes.

6. The method as claimed in claim 5, comprising configuring the first interface of the switch node using routing data from the access node which, in the series configuration, connects to the network.

7. The method as claimed in claim 5, which comprises configuring the second interface of the node using routing data from an interface of the access node which cross-connects from that interface of the access node to another interface of the access node.

8. The method as claimed in claim 1, comprising removing from the access nodes connection configuration data for cross-connecting traffic from one interface to another interface of an access node, which connection configuration data enable traffic to be conveyed from one access node to another access node when the access nodes are connected in series.

9. The method as claimed in claim 1, which comprises using a data processor connected to one of the access nodes, when the nodes are connected in series, to collect the connection configuration data.

10. The method as claimed in claim 9, which comprises inputting to the data processor identification data of the access nodes.

11. A network management processor configured to collect connection configuration data from a plurality of network access nodes connected in series in an access network, and the network management processor configured to configure a switch node using at least some of the connection configuration data, and/or data derived from the connection configuration data, such that the switch node is configured to allow communication between a communications network and the network access nodes via the switch node.

12. The network management processor as claimed in claim 11, configured to process the collected configuration data such that the switch node can communicate with each of the access nodes by way of a respective link.

13. A nontransitory machine readable storage medium having stored thereon instructions which, when run by a data processor, cause the data processor to collect connection configuration data from a plurality of network access nodes connected in series in an access network, and the instructions further cause the data processor to use at least some of the connection configuration data, and/or data derived from the connection configuration data, to configure a switch node such that the switch node is configured to allow communication between a communications network and the network access nodes via the switch node.
